(19) United States
(12) Patent Application Publication
(10) Pub. No.: US 2023/0388895 A1
(43) Pub. Date: Nov. 30, 2023

(54) METHODS AND SYSTEMS FOR PROVIDING WIRELESS BROADBAND USING A LOCAL MESH NETWORK

(71) Applicant: Gigaband IP, LLC, Chandler, AZ (US)

(72) Inventor: Michael Golden, Chandler, AZ (US)

(21) Appl. No.: 18/199,648

(22) Filed: May 19, 2023

Related U.S. Application Data
(60) Provisional application No. 63/345,414, filed on May 24, 2022.

(51) Int. Cl. H04W 40/12; H04W 40/24

(52) U.S. Cl. CPC H04W 40/12; H04W 40/248; H04W 84/18

(57) ABSTRACT

A mesh network comprises a plurality of nodes, each one wirelessly connected to at least another such node in the network. Each of the nodes includes a housing containing therein a plurality of radios arranged equidistantly around a central axis. The mesh network includes an anchor node. The anchor node is communicably coupled to a wireless bidirectional point-to-point link. The point-to-point link can be communicably coupled to cable or fiber broadband. The nodes can receive data from, and send data to, neighboring nodes. The nodes include a router that selects the next node and a radio-to-radio link between the current node and the next node. A communication path includes at one end the anchor node and at the other end an access point. Between the ends, there may be additional nodes forming a multi-hop path. The mesh network supports Internet protocols such as IP/TCP to provide wireless Internet access.

### CROSS-REFERENCE TO RELATED APPLICATIONS

This application claims the benefit of provisional application Ser. No. 63/345,414, filed May 24, 2022, the subject matter of which is incorporated herein by reference.

### BACKGROUND OF THE INVENTION

### 1. Field

The present disclosure relates to methods and systems for providing wireless broadband using a local mesh network.

### 2. Description of the Related Art

Wireless mesh networks having nodes each with a single radio that can communicate with other such nodes and pass data packets from one node to another and finally to a destination point are known in the art.

### SUMMARY

A mesh network comprises a plurality of nodes, each one wirelessly connected to at least another such node in the network. Each of the nodes includes a housing containing therein a plurality of radios arranged substantially equidistantly around a central axis. In degrees, the beam spread of each of the radios equals n/360°, where n represents the total number of radios in the node. As a non-limiting example, a node having six radios would have a beam spread of 60° for each radio. In this example, the six radios, each with a 60° beam spread, combine to support connections with other nodes in the network located anywhere within 360°.

The mesh network includes an anchor node. The anchor node is communicably coupled to a wireless bidirectional point-to-point link. The point-to-point link can be communicably coupled to cable or fiber broadband. The nodes can receive data from, and send data to, neighboring nodes. A communication path includes at one end the anchor node and at the other end an access point. Between the ends, there may be other nodes forming a multi-hop path.

The mesh network supports Internet protocols such as IP/TCP to provide wireless Internet access to localities without immediate access to cable or fiber infrastructure. The mesh network can be used to provide wireless high-speed Internet access to individual users in a local community. Non-limiting examples of such communities include apartment buildings, hotels, universities, business campuses, and home-owner associations in exurban or rural areas.

The radios of each of the nodes have polarized antennas. In an embodiment, the nodes have n sides or facets corresponding to n radios. Each facet includes a first antenna that is a right circularly polarized antenna and a second antenna that is a left circularly polarized antenna. The data streams between the first node and the second node can be combined from a respective right circularly polarized antenna and left circularly polarized antenna. Each of the first node and the second node can have a respective additional left-hand circularly polarized antenna capable of detecting and combining reflected out-of-phase data streams to increase bandwidth should reflective surfaces become available.

Each of the nodes includes a computing device having a processor and storage. The computing device acts as a router that selects the next node and a radio-to-radio link between the current node and the next node. The storage can include tables having historical information regarding transmission quality and throughput between the nodes, for example. Using the historical information, it can be determined which radios on other nodes in the network can support the potentially highest throughput for upstream (or downstream) multi-hop connections to (or from) the anchor node. The processor continuously surveys other nodes in the network to determine if historically used paths between node radios have improved or deteriorated, identifying whether new nodes have been activated in the network and re-maps the best multi-hop paths for every newly added or deleted node. Additionally, certain policies can be enforced such as not allowing wireless connections between two radios on the same node. Firmware can be updated from time to time to improve the optimization algorithms used and/or to change policies.

The nodes can operate reliably in a wide range of weather conditions. A novel technique developed is to attach each radio chip in a node (a significant source of heat) to a vertical metal plate using heat-transmitting grease or tape. These plates are then attached using grease or tape to the inside side of the metal heat sink which radiates and directs that heat to the outside air at the base of the node. In addition, the processor, another significant source of heat, is attached to the bottom of the router PCB and coupled directly to a heat sink that is the base of the node. A notable benefit of this method for removing internally generated heat from a node is that fans and/or vents aren't needed to keep the node working while remaining completely weatherproof.

Every node in the network is in continual communication with a Network Management System (NMS). The NMS can be connected to an output device (e.g., a computer monitor, a smartphone, a tablet) that can display icons or the like representing the network nodes superimposed on a map (such as a satellite image map) of their actual geographic locations using pre-determined GPS locations for each node. Additionally, each node installed in the network has its sector-one radio physically aligned due North. This allows the NMS software to display the radio-to-radio connections using the correct sides of each node icon on the satellite image. Further, each radio-to-radio connection displayed on the map shows the average transmit and receive throughputs between radio pairs for arbitrary units of time. This capability provides at-a-glance diagnostics of potential network and node operational problems.

The NMS includes a data store that stores images of node firmware and supports remote upgrading or downgrading of node operational firmware over the network. It also can provide alarms if/when nodes fail and the map displays are instantly updated with the newly updated network configuration.

The NMS also supports the validation of end users' connections to nodes using radius authentication servers. It can instruct nodes to limit the bandwidth available to specific end users and can provide useful data to 3^{rd} party billing systems.

In general, the system is decentralized. However, the capability exists of using the NMS to review local path decisions and override them either manually or automatically. This might be used to change node decision-weighting factors based on seasonal foliage changes, for example. It can also be used to modify radio sub-band choice criteria based on historically known third-party radio interference or jamming, as another example. Each node has a table with historical data for every radio of every node which is used locally in real-time and uploaded to the NMS's database in the background for later evaluation and improvements in network optimization.

### BRIEF DESCRIPTION OF THE DRAWINGS

FIG. 1 is a diagram illustrating an example node for a mesh network, according to an embodiment.

FIG. 2 is a perspective view of an example node of the mesh network, according to an embodiment.

FIG. 3 is a diagram showing communication among nodes of an example mesh network, according to an embodiment.

FIGS. 4A-4B is a flow diagram of a process for establishing the paths of a mesh network with the highest transmission quality.

FIG. 5 is a diagram showing a processing system of a node of the mesh network, according to an embodiment.

FIG. 6 is a diagram showing the network architecture of a system for managing the mesh network, according to an embodiment.

FIG. 7 is an example display showing icons representing network nodes superimposed on a satellite image map.

### DETAILED DESCRIPTION

Internet connectivity is widely recognized as a crucial feature of modern life. Indeed, it has become increasingly difficult to participate in society without it. Furthermore, for many purposes, Internet speed is almost as important as access.

According to 2019 census data, 23 million households in the United States do not have high-speed (broadband) access. A major reason for this was found to be a lack of availability. Outside the denser metropolitan (urban and suburban) localities, it is extremely expensive to extend cable and/or fiber to fewer and fewer customers per square mile. Thus, broadband availability in exurban and rural areas is generally lacking.

The present disclosure relates to enhanced techniques for providing wireless broadband to such localities using a local mesh network

Among other aspects, the present disclosure envisages the mesh network having an anchor node in communication with fiber or cable broadband via a wireless bidirectional point-to-point link.

Among other aspects, the present disclosure envisages the mesh network having nodes each containing multiple radios. As will be described in greater detail, the radios are arranged within an antenna structure along a 360° radius.

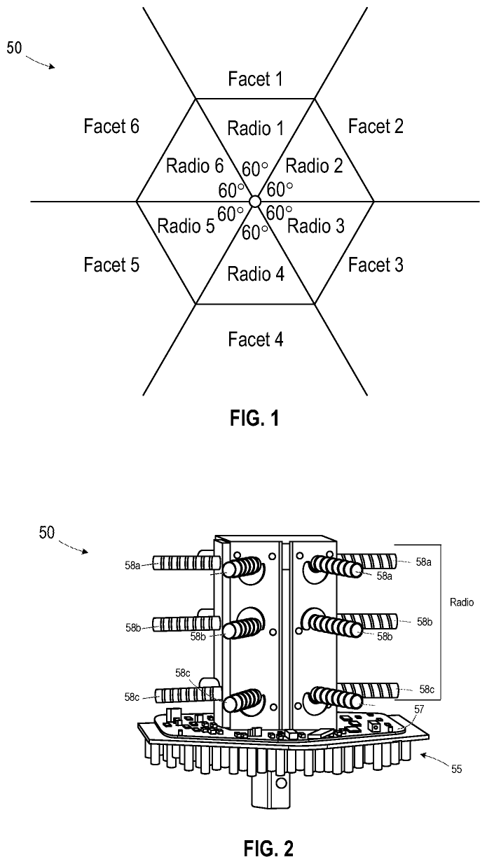

Referring to FIG. 1, an example architecture for a single node 50 of a mesh network 100, according to an embodiment, is illustrated. As shown, there are six facets (sides) 55 to the antenna structure encompassing node 50. Polarized antennas are used for each of six radios (labeled 1-6) in node 50 to create 60° highly directional signals to improve signal gain to/from each radio and to minimize signal interference both to the sides and to the rear of a given antenna with other radios in the same node. The six radios, each with a 60° beam spread combine to support connections with other nodes in the network located anywhere within 360°. Although the number of radios in node 50 of the mesh network is arbitrary, the number of radios in the nodes will match 360° divided by the beamwidth of each radio in degrees to support connections to other nodes in all directions.

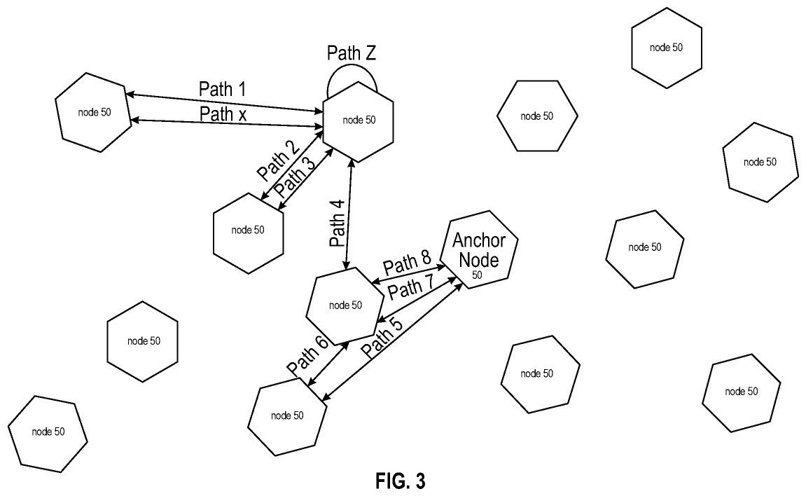

Using conventional radio arrangements, a problem was found to exist when using commercially available OFDM (orthogonal frequency division multiplexing) radios which rely on built-in signal processing to increase throughput by combining out-of-phase reflected signal signals in indoor environments. These types of radios have limited throughput when used in outdoor line-of-sight environments where no signal reflections are available. The present embodiment maximizes line-of-site throughput between radios by “spoofing” the radio's built-in OFDM signal processing algorithms. Among other aspects, the present disclosure envisages a solution to this problem by employing a set of antennas 58a, 58b, and 58c for each of the radios. The set of antennas 58a, 58b, and 58c includes left and right circularly polarized antennas 58a, 58b for line-of-site communication between two radios when there are no available reflective surfaces in the paths between the two radios to “spoof” the built-in OFDM signal processors in the radios to recognize and combine the separate left- and right-hand polarized data streams to double the available bandwidth between the radios as opposed to the single data stream that would normally be available under line-of-site conditions. A third left-hand antenna 58c is also provided which can work with the righthand antenna to detect and combine reflected out-of-phase data streams to increase bandwidth should reflective surfaces become available in a specific environment. FIG. 2 shows an example of a multifaceted antenna structure (without a covering) having these three types of polarized antennas 58a, 58b, and 58c on the radios serving in each facet.

The nodes 50 must operate reliably in a wide range of weather conditions. A novel technique developed is to attach each radio chip in a node (a significant source of heat) to a vertical metal plate using heat-transmitting grease or tape (not shown). These plates are then attached using grease or tape to the inside side of the metal heat sink 55 which radiates and directs that heat to the outside air at the base of the node 50. In addition, the processor, another significant source of heat is attached to the bottom of the router PCB 57 and coupled directly to a heat sink that is the base of the node. A notable benefit of this method for removing internally generated heat from a node is that fans and/or vents aren't needed to keep the node working while remaining completely weatherproof.

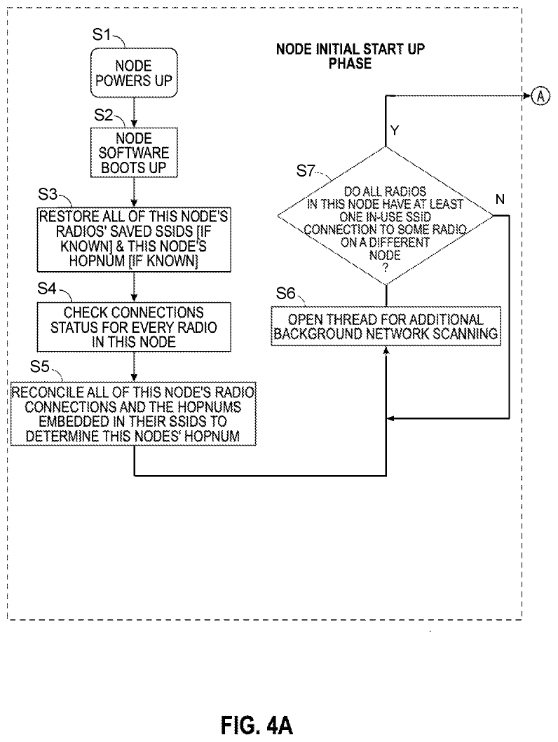

Referring to FIG. 3, a diagram showing communication among nodes 50 of the example mesh network 100, according to an embodiment, is illustrated. The example mesh network 100 includes an anchor node 50 which is the node in communication with an outside network. The nodes 50 include a router that selects the next node and a radio-to-radio link between the current node and the next node. A communication path includes at one end the anchor node and at the other end an access point. Between the ends, there may be additional nodes 50 in a multi-hop path. The mesh network 100 supports known Internet protocols such as IP/TCP to provide wireless Internet access.

Note that in the illustrated network shown in FIG. 3, path Z is not allowed because one radio on a node should not connect wirelessly to another radio on the same node. Path X is also not allowed because a radio cannot have multiple paths to the same radio on another node because of routing conflicts. However, all the other shown paths are allowed. All radios are set up in bridge mode, but the level 3 algorithm implemented in the nodes includes a policy to not enforce creating path types exemplified by path X and path Z. The best paths can be chosen by first applying a technique to filter available paths taking into consideration transmission quality and signal strength, and then choosing the subset of the filtered paths by applying a suitable routing protocol such as the open-source B.A.T.M.A.N (Better Approach to Mobile Ad-hoc Networking) IV or an IEEE standard, for example.

Conventional approaches for self-managed mesh networks assume nodes have a single radio which communicates to other nodes within a 360° radius from each node in a network. The use of multiple radios arranged as in the present embodiment provides several improvements in mesh network behavior over conventional single radio implementations. A single radio in a mesh node that is relaying duplex traffic will lose half of the available bandwidth with each relay hop through the mesh. Whereas on mesh networks with multi-radio nodes, a node can route traffic received on one of its radios to another radio on that node with no loss in bandwidth, dramatically improving the hop-to-hop throughput in the network.

Because the nodes in the mesh network 100 in the present embodiment are each equipped with multiple radios the problem that each node 50 must solve to determine which radio on which node to connect with is greatly complicated. Because most of the radios on a potential next-hop node will not necessarily represent the best choice in terms of signal quality since most are likely aimed in undesirable directions.

Thus, the problem becomes how to cause each multiple-radio node 50 in a multi-hop mesh network 100 to determine which is the best radio on a possible next-hop node, to connect to assure that data packets are efficiently transmitted both downstream and upstream using the shortest hop path possible based on signal quality and node position relative to the anchor node and its Internet connection. The IEEE 802.11s protocol does a good job of figuring out the shortest node-to-node path between nodes but is not sufficient for choosing the best radio-to-radio path in a mesh network where the nodes have multiple radios and where certain paths between radios need to be blocked and signal quality between possible radio pairs can vary significantly.

Among other aspects, the present disclosure envisages a computer-implemented method to establish the paths with the highest transmission quality and effective bandwidth over the selected possible paths of the mesh network and then apply a suitable standard routing protocol for wireless ad-hoc networks such as the open-source B.A.T.M.A.N. IV or an IEEE standard.

In particular, the method steps include
reading and writing radio link performance and configuration information as well as historical signal-to-noise and throughput data to/from each radio in each network node in the network for connections between every other radio in every network node in the network;
supporting a packet router function in each network node, the router connected to the transmit/receive ports of each radio in a node as well as the external wired WAN and LAN ports on each node;
determining which radios on other nodes in the network can support the potentially highest throughput for up-stream or down-stream multi-hop connections to/from the network's anchor node;
continuously surveying other nodes in the network to see if historically used paths between node radios have improved or deteriorated, identify if new nodes have been activated in the network, and re-mapping the best multi-hop paths for every newly added or deleted node;
blocking wireless connections from being established between two radios on the same node to or to the same radio on another node; and
determining heuristically which nodes and radios in a potential up-stream or downstream multi-hop path have had radios with links to other radios in the network that have had the best current and historically measured signal quality as determined by each radio's signal-to-noise for connections to specific other radios on other nodes, as well as transmitting/receiving gains and packet throughput rates; then choosing to connect one of its radios to another node and its radio having the best of these characteristics.

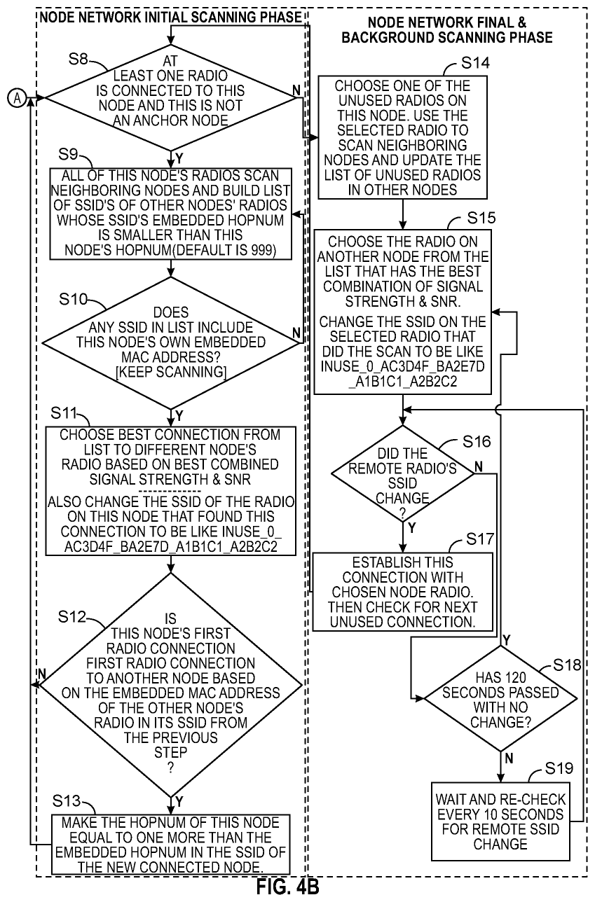

Referring to FIGS. 4A-4B, a flow diagram of an example process for establishing the paths with the highest transmission quality, according to an embodiment, is illustrated. The process is executed in each of the nodes 50 in three phases, namely the Node Initial Startup Phase, Node Network Initial Scanning Phase, and Node Network Final and Background Scanning Phase, as discussed below.

Node Initial Startup Phase

Initially, in step S1, the node powers up. Then, in step S2, the node's software boots up. Once this is done, in step S3, each radio identifier (e.g., SSID) (if known) is restored from memory along with the node's “hop number” (“hopnum”) (if known). In general, the hop number keeps track of where a node is located relative to the anchor node. This assures that traffic originating at a given node directed upstream is directed to a node with a lower “hopnum” than itself. Conversely, downstream traffic is directed to a node with a higher number if the traffic it receives is not intended for itself. This concept prevents circular traffic from occurring within a network of nodes. In step S4, the status of each radio in the node is checked for connectivity. In step S5, a table is consulted to see if there exists a stored record for each of the node's radios of a pre-established identifier (e.g., SSID) used to connect to preferred radio choices on other nodes. If any radio in the node can establish a connection to the anchor node using any of its radios' broadcast identifiers and the “hopnum” embedded in that identifier is set to 0, then the node recognizes that it has a potential connection to the anchor node. Then the node further examines the relative signal quality for each of the radios' connections. If any radio detects a connection on one of its radios to a radio on another node using an identifier having a “hopnum” of 0 and the signal quality is at least equal to or better than the other radios on the node, then the node recognizes it is one “hop” distant from the anchor node and assigns itself a “hopnum” of 1 on all of the node's identifiers that are broadcast for each of its radios. Note that if the node finds previously assigned connections in the table, it will use those to shorten the startup time required, and background processing will periodically check signal quality on all of its radios and will scan for other possible radios on other nodes. Moreover, if it finds a better connection to a node with either a lower or higher “hopnum” it will switch to that connection and record the new connection in the table. In step S7, if no connection to another node is found this step will loop back to step S6 to continue looking for and assigning new connections. In step 6, once at least one connection is established to another node by a node, then a background process is initiated for the node which continues to look for optimal connections (based on signal quality) to the radios of other nodes to support upstream (lower “hopnums”) and downstream (higher “hopnums”) connections relative to the anchor node.

Node Network Initial Scanning Phase

Step S8 directs the process flow to the steps required by a regular node as distinguished from an anchor node. Step S9 builds a list of potential upstream node connections. Step 10 filters out the possibility of connections to other radios on itself. Steps 11-13 examine each of the potential connections to other nodes' radios and for each of its radios, selects SSID from among the other radios that offer the best signal quality (and optional throughput measurement). Then the node software changes the SSID of the radio that identified this “best connection” to a format that shows that this radio is in use and connected to a radio on the other node whose radio's unique MAC address in the radio it is connecter ed to. The newly connecting radio examines its database to determine if this is the first connection that it has made to another node. If so, it looks at the SSID of the other node to determine that node's “hopnum” and assigns itself a “hopnum” that is 1 higher than the “hopnum” embedded in the SSID it is connecting to. It then embeds this new “hopnum” in the SSIDs being broadcast by all of its radios.

Background Scanning Phase

In Step S14, after the first radio of a node established its first upstream either directly to an anchor node, or an anchor node via any upstream node, a node begins looping through a repetitive process to establish “best quality” upstream (and therefore downstream) connections to radios on other nodes. One of the values of storing current connection SSIDs in a node's database is that the node is not forced to go through the initialization phase every time it is rebooted. Meaning the nodes and the network will rapidly back online after any power disruption. If after a node's reboot, a previous connection has been degraded or lost, the background process will identify new connections that can be assigned after a short time has passed.

In Step 15, the same process that was used in Step 11 is used to keep looking for the best possible connection and modifying the SSID format to reflect a new and different connection if the scans of signal quality indicate a different connection would be better than the current one. Also, this step would notice a lost connection and scan to find a new one. Steps 18-21 support the process of establishing a new and better connection if a current one is lost or degrades in quality below what new scans of available radios on other nodes show what is currently available for potential new connections. If a remote radio's SSID changes, Steps 18 and 19 provide timers to initiate new scans for replacement connections to other nodes.

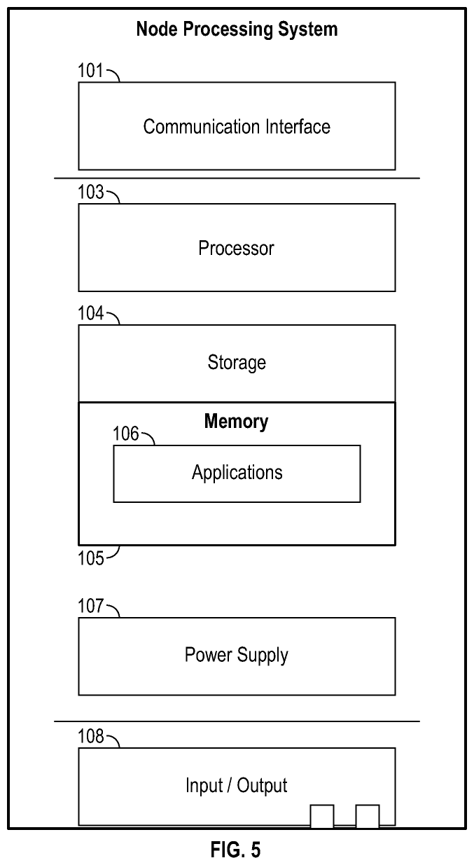

Referring to FIG. 5, a diagram showing a processing system of a node in the mesh network, according to an embodiment, is illustrated. It is to be understood that each node 50 in the mesh network 100 would have the same or similar arrangement. As depicted, an example computing device 120 includes a communication interface 101, a processor 103, storage, memory 105, a power supply 107, and digital input/output ports 109. In an embodiment where the computing device is a microprocessor, the communication interface 101 includes multiple transmitter and receiver ports. Processor 103 includes at least one central processing unit (CPU). The storage 104 can include ROM/RAM, flash memory, and the like. The power supply 109 can include power regulators to produce the different voltages required by the various components. Software and firmware applications 106 can be stored in the memory 105 and include program code non-transitorily embedded thereon. This program code includes various programs executable by the processor such as code to boot up the process at start-up, code to support remote updating of node firmware, and algorithms 103. In the foregoing description of the present invention, exemplary methods for performing various aspects of the present invention are disclosed. It is to be understood that the steps illustrated herein can be performed by executing computer program code written in a variety of suitable programming languages, such as C, C++, C #, and Java.

In an implementation, for each node, the processor 103 is a multicore processor and the memory 105 has two flash memory arrays plus RAM. The two flash arrays allow for two versions of firmware to be stored in each node—the running version and a downloaded upgrade. This allows for a nearly instant cut-over from a running version and an upgrade version. It also allows for fail-back in the new upgrade version fails. There is also another memory area that stores the boot and kernel code which can only be updated by physically attaching a computer to the node processor. The processor and separate PCIe Ethernet switches on the processor PCB connect high-speed Ethernet traffic to PCIe interfaces on each radio. The computing device acts as a router that selects the next node and a radio-to-radio link between the current node and the next node. Processor 103 runs real-time routing code in addition to evaluating link quality, managing the historical connection quality database, and background communications with a Network Management System (NMS).

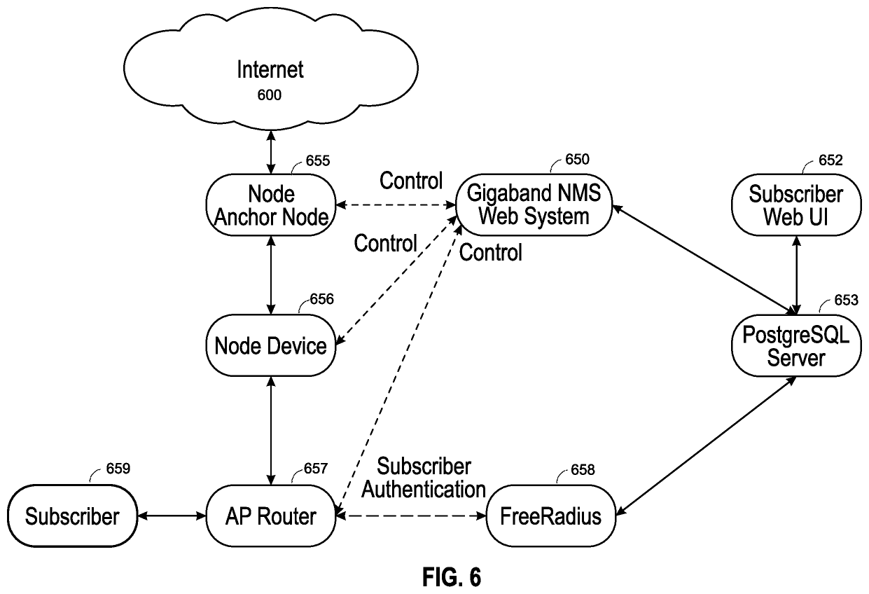

Referring to FIG. 6, a diagram showing the network architecture of an example system for managing the mesh network 100, according to an embodiment, is provided. As shown, a subscriber 659 can access the Internet via an access point (AP) router 657. Initially, the subscriber 659 can log in to an authenticator. As shown the authenticator is the open-source FreeRadius 658 which is connected to a PostgreSQL server 653. Once authenticated, the subscriber 659 can access the Internet 600. The subscriber 659 can also access the Network Management System (NMS) 650 via a Subscriber Web User Interface (UI) 652 to obtain account information, billing information, and so forth. It is to be understood that although FIG. 6 shows only one subscriber there would generally be many more subscribers in the mesh network 100. Furthermore, it is to be understood that although the diagram only shows a single node device 656 there would generally be many more such nodes in the mesh network 100.

As shown, the NMS 650 controls and manages an anchor node 655, the node device 656, and the access point (AP) router 657. As mentioned, the anchor node 655 is connected to Internet 600 via a point-to-point link. It is to be appreciated that FIG. 6 is a simplified diagram and that many more nodes would exist, each in continual communication with the NMS 650.

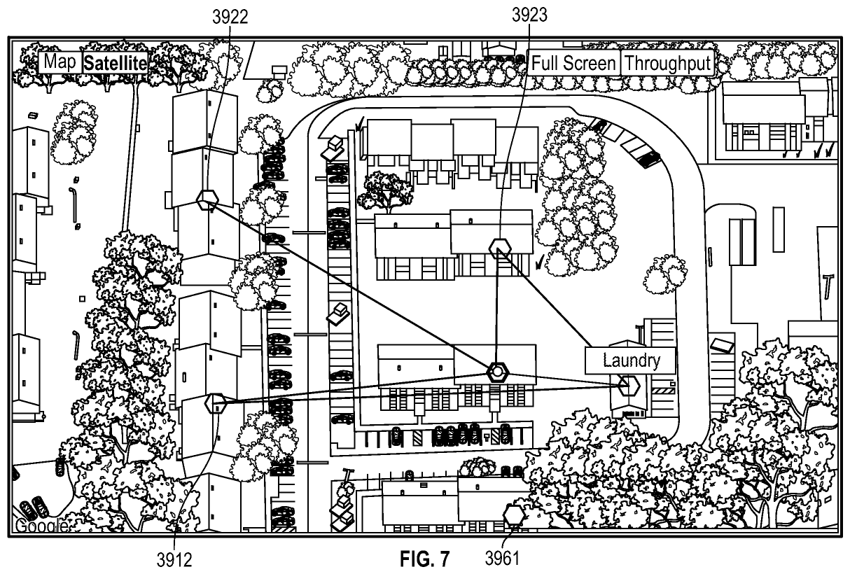

In an embodiment, the NMS 650 can monitor and display icons or the like representing the network nodes superimposed on a map (such as a satellite image) of their actual geographic locations using pre-determined GPS locations for each node. FIG. 7 shows an example of such a map for a representative apartment community. For example, as shown, apartment buildings 3912, 3922, 3923, and 3961 have node devices mounted on their respective roofs. Additionally, there can be other such nodes, for example, on the roof of the laundry room. The background image is a satellite image of the apartment complex and each of the nodes is superimposed on the map based on their exact GPS coordinates (e.g., the latitude and longitude). It is to be understood that the node devices could be mounted on other areas other than roofs so long as radio signals can be maintained.

Additionally, each node installed in the mesh network 100 has its sector-one radio physically aligned due North. This allows the NMS 650 to display the radio-to-radio connections using the correct sides of each node icon on the satellite image. An additional novel feature is that each radio-to-radio connection displayed on the map is that each connection can show the average transmit and receive throughputs between radio pairs for arbitrary units of time. This capability provides at-a-glance diagnostics of potential network and node operational problems.

Furthermore, the NMS 650 can store images of node firmware and supports remote upgrading or downgrading of node operational firmware over the network. It also can provide alarms if/when nodes fail and the satellite map displays are instantly updated with the newly updated network configuration.

The NMS 650 also can support the validation of subscriber connections to nodes using the appropriate authenticator (such as the FreeRadius 658). The NMS 650 can instruct nodes to limit the bandwidth available to specific end users and can provide useful data to 3rd party billing systems.

In general, the system is decentralized. However, the capability exists of using the NMS 650 to review local path decisions and override them either manually or automatically. This might be used to change node decision-weighting factors based on seasonal foliage changes or changing radio sub-band choice criteria based on historically known third-party radio interference or jamming, for example. Each node has a table with historical data for every radio of every node which is used locally in real-time and uploaded to the database of the NMS 650 in the background for later evaluation and improvements in node algorithms. The radios can be queried for TX and RX link gains, link throughputs, link transmit and receive power, and link SNR. These data can be provided in real-time or averaged over arbitrary units of time to refine how algorithms combine the different types of link data for predicting optimum throughput.

As mentioned, the present disclosure envisages providing wireless broadband to certain localities without immediate fiber or cable access. Each locality can include a wireless mesh network such as described herein serving the locality by providing high-speed Internet access to individual users. Examples of such localities include apartment buildings, hotels, universities, business campuses, and home-owner associations. Connectivity with a cable or fiber connection situated several miles away can be achieved by utilizing a wireless bidirectional point-to-point link (such as, for example, by utilizing an airFiber™ radio system by Ubiquiti, Inc.).

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A mesh network, comprising:
a plurality of nodes, each one wirelessly connected to at least another such node in the network;
wherein each of the nodes includes a housing including therein a a plurality of radios arranged equidistantly around a central axis.

2. The mesh network of claim 1 wherein, in degrees, beam spread of each of the radios equals n/360, where n represents the total number of radios in the node.

3. The mesh network of claim 1, where one of the nodes is an anchor node connected to a wireless bidirectional point-to-point link.

4. The mesh network of claim 3, wherein the anchor node is wirelessly coupled to a broadband connection using the wireless bidirectional point-to-point link.

5. The mesh network of claim 4, wherein the anchor node is wirelessly coupled to a fiber connection using the wireless bidirectional point-to-point link.

6. The mesh network of claim 1, wherein the nodes are each capable of bidirectional communication.

7. The mesh network of claim 1, wherein each of the radios includes a polarized antenna.

8. The mesh network of claim 1, wherein a first node of the plurality of nodes include a left circularly polarized antenna and a second node of the plurality of nodes, in communication with the first node, includes a right circularly polarized antenna.

9. The mesh network of claim 9, wherein data streams between the first node and the second node are combined.

10. The mesh network of claim 9, wherein each of the first node and the second node has a respective additional left-hand circularly polarized antenna capable of detecting and combining reflected out-of-phase data streams to increase bandwidth should reflective surfaces become available.

11. The mesh network of claim 1, wherein nodes are capable of receiving data and sending data, a final one of the nodes in a communication path of the network being a destination node.

12. The mesh network of claim 11, wherein the storage stores historical information regarding transmission quality and throughput between the nodes.

13. The mesh network of claim 14, wherein the processor, using the historical information determines which radios on other nodes in the network can support the potentially highest throughput for upstream or downstream multi-hop connections to/from the anchor node.

14. The mesh network of claim 15, wherein the processor continuously surveys other nodes in the network to determine if historically used paths between node radios have improved or deteriorated, identifying whether new nodes have been activated in the network, and re-maps the best multi-hop paths for every newly added or deleted node.

15. The mesh network of claim 16, wherein the processor blocks wireless connections from being established between two radios on the same node.

16. The mesh network of claim 15, wherein a processor
determines heuristically which nodes and radios in a potential up-stream or downstream multi-hop path have had radios with links to other radios in the network that have had the best current and historically measured signal quality as determined by each radio's signal-to-noise for connections to specific other radios on other nodes;
transmits/receives gains and packet throughput rates; and
selects for wireless connections optimal radio pairings.
The mesh network of claim 1, wherein a processor of each of the nodes are coupled directly to a heat sink that is at the base of the node.

17. The mesh network of claim 1, further including a Network Management System (NMS) in communication with the nodes.

18. The mesh network of claim 22, wherein the NMS is connected to an output device that displays representations of the nodes superimposed on a map.

19. The mesh network of claim 23, wherein the map includes a satellite image.

20. The mesh network of claim 23, wherein the map includes location information for each of the nodes.
